(19) United States
(12) Patent Application Publication
(10) Pub. No.: US 2005/0213962 A1
(43) Pub. Date: Sep. 29, 2005

(54) Firearm Scope Method and Apparatus for Improving Firing Accuracy

(76) Inventor: Terry J. Gordon, Keeseville, NY (US)

Correspondence Address: LAW OFFICE OF JAY R. YABLON, 910 NORTHUMBERLAND DRIVE, SCHENECTADY, NY, 12309-2814, US

(21) Appl. No.: 10/904,779

(22) Filed: Nov. 29, 2004

Related U.S. Application Data
(63) Continuation-in-part of application No. 10/711,267, filed on Sep. 7, 2004.
Application No. 10/711,267 is a continuation of application No. 10/250,148, filed on Jun. 6, 2003, now Pat. No. 6,792,206.
Application No. 10/250,148 is a continuation of application No. 10/063,033, filed on Mar. 13, 2002, now Pat. No. 6,580,876.
Application No. 10/063,033 is a continuation of application No. 09/537,325, filed on Mar. 29, 2000, now Pat. No. 6,363,223.

(51) Int. Cl. G03B 17/38; F41G 1/38

(52) U.S. Cl. 396/502; 42/122

(57) ABSTRACT

A firearm scope and related method is disclosed, comprising: a movable aiming icon viewed juxtaposed with images of a target, automatically movable in relation to the images of the target based on at least one accuracy-affecting factor; whereby: the movable aiming icon can be used to aim the firearm at the target while accounting for the at least one accuracy-affecting factor. Additionally, a firearm scope and related method is disclosed, comprising: a viewing monitor for displaying in real time, target images captured by a digital imaging array for capturing photographic images of a target; and the viewing monitor situated in relation to the firearm scope, wherein the target images displayed thereon are viewable by a person firing the firearm when firing the firearm; whereby: the target images displayed on the viewing monitor can be used to aim the firearm at the target without parallax misalignment due to variation in positioning of an eye of the person firing the firearm.

### CROSS-REFERENCE TO RELATED APPLICATIONS

This application is a continuation-in-part of pending U.S. application Ser. No. 10/711,267 filed Sep. 7, 2004, which in turn is a continuation of U.S. application Ser. No. 10/250,148 filed Jun. 6, 2003, now U.S. Pat. No. 6,792,206 issued Sep. 14, 2004; which in turn is a continuation of U.S. application Ser. No. 10/063,033 filed Mar. 13, 2002, now U.S. Pat. No. 6,580,876 issued Jun. 17, 2003; which in turn is a continuation of U.S. application Ser. No. 09/537,325 filed Mar. 29, 2000, now U.S. Pat. No. 6,363,223 issued Mar. 26, 2002, all of which are hereby incorporated by reference.

### FIELD OF THE INVENTION

This invention relates generally to firearms, and in particular to ways of improving accuracy when a firearm is aimed and fired. Background of the Invention

Commonly-invented U.S. Pat. Nos. 6,000,163; 6,363,223; and 6,580,876; and patent application Ser. No. 10/250,148; all disclose a method and apparatus for recording photographs in connection with the firing of a firearm, which entails detecting a time zero when live ammunition is actually discharged from the firearm and saving at least one photographic image frame of an image of a target based upon detecting that time zero.

One of the components which facilitates this method and apparatus is the digital photography means 106 illustrated in FIGS. 1 and 4, and detailed in FIGS. 2 and 5, which along with FIGS. 3 and 6 are reproduced herein without change from U.S. Pat. Nos. 6,363,223; and 6,580,876; and patent application Ser. No. 10/250,148. (FIGS. 1-3 are reproduced also from U.S. Pat. No. 6,000,163.)

A common denominator between photographic devices such as cameras, and firearm scopes, is that each employs optical lenses. Traditionally, however, the use of a camera in direct conjunction with a firearm was not widely practiced. Where it was practiced, such as in several of the prior art references cited in U.S. Pat. Nos. 6,000,163; 6,363,223; and 6,580,876; and patent application Ser. No. 10/250,148, the purpose of the camera was to photograph the target in some manner, rather than to enhance the accuracy with which the weapon was fired.

Commonly-invented U.S. Pat. Nos. 6,000,163; 6,363,223; and 6,580,876; and patent application Ser. No. 10/250,148 for the first time provided the ability to photograph the target in extremely precise coordination with the firing of the firearm, by detecting a time zero when live ammunition is actually discharged from the firearm and saving at least one photographic image frame of an image of a target based upon detecting that time zero. Two primary embodiments for achieving this make use of an acceleration detector detecting a recoil of the firearm when the firearm is fired, and an acoustic detector detecting a sound of the firearm when the firearm is fired.

While a primary use of the technology disclosed in commonly-invented U.S. Pat. Nos. 6,000,163; 6,363,223; and 6,580,876; and patent application Ser. No. 10/250,148 is for taking photographs, this technology also yields the collateral benefit of improved firing accuracy. In particular, a photographic record taken in real time through the firearm scope, showing both where the scope was pointing at the time of firing as well as where the live ammunition actually impacted, provides the basis for determining with precision, the degree of any inaccurate aiming of the firearm in relation to the target, whether this is due simply to poor shooting, a misalignment of the scope in relation to the barrel of the firearm, or other transient factors such as environmental conditions (e.g., wind), and/or variations in the distance and inclination of the target from the shooter. Indeed, such a record can even help to differentiate which of the aforementioned factors contributed to the inaccurately-aimed shot.

For example, the photographic record might establish that the scope was not aimed directly at the target, and that the ammunition struck precisely where the scope was inaccurately-aimed, indicating a poor shot of a properly-calibrated firearm. The photographic record may also establish that the scope was indeed aimed directly at the target, but that the ammunition struck other than where the scope was aimed. This would indicate that the scope was misaligned with the barrel, that environmental conditions were a factor, that distance or inclination to the target was not properly taken into account and that the scope should actually have been aimed further above or below the target, or that the ballistics of the firearm and ammunition was not properly accounted for.

All of this post-facto, retrospective information can be very helpful in producing better accuracy for the nextshot, but it does nothing in relation to the present, prospective shot about to be fired.

Therefore, it would be desirable to make use of the technology foundation provided in commonly-invented U.S. Pat. Nos. 6,000,163; 6,363,223; and 6,580,876; and patent application Ser. No. 10/250,148, in real time, to improve the prospective accuracy with which a firearm is fired.

Firing accuracy is impacted by a number of factors. More to the point, a number of accuracy-affecting factors must be accounted for to achieve highly-accurate firing, and if they are not, the shot which is fired will not be as accurate as it can or should be.

First, it is desirable to account for environmental conditions such as, but not limited to, wind velocity (speed and direction), temperature, barometric pressure, relative humidity, elevation above sea level, dew point, wind chill, wet bulb temperature, heat stress, and density altitude. The prior art does disclose environmental conditions monitors which measure some or all of these above-noted conditions. See, for example, U.S. Pat. Nos. 5,783,753 and 5,939,645 and 6,257,074.

Second, it is desirable to account for distance to target. Various distance detectors for this purpose, e.g., laser range finders, are well-known in the art. Commonly-invented U.S. Pat. Nos. 6,000,163; 6,363,223; and 6,580,876; and patent application Ser. No. 10/250,148, for example, already incorporate a distance detector designated therein as 114.

Third, it is desirable to account for inclination to target. Various inclination meters for this purpose are also well-known in the art.

Fourth, it is desirable to account for ballistic properties of the firearm and ammunition being employed. See, for example, commonly-invented U.S. Pat. Nos. 6,000,163; 6,363,223; and 6,580,876; and patent application Ser. No. 10/250,148, in which “appropriate ballistics information is pre-programmed into computer 110,” e.g., U.S. Pat. No. 6,000,163 at column 6, lines 49-53.

Finally, the optical phenomenon of parallax misalignment is often a frequent cause for inaccurate firing of a scope-based firearm. That is, when firing a scope-based firearm, it is necessary for the person firing the firearm to align his or her eye 103 precisely behind the center line (optical axis) 104 of the scope. A slight misalignment of the eye will cause the reticular lens of the scope in show a slightly-different alignment to the target which will then cause the person firing to aim the firearm slightly differently.

Further, even when the shooter has properly determined environmental conditions, distance to target, and/or inclination to target, and has made proper use of the ballistics of the firearm and ammunition, there is the central question of how to adjust the aiming of the firearm to simultaneously account for all of these factors.

The prior art does teach gunsight reticles with superimposed grids, such that the shooter knows to center his or her target on a particular grid coordinate, rather than on the “center” “crosshairs” of the reticle, based on environmental conditions, distance to target, and/or inclination to target, as well as ballistics. Such reticles are disclosed, for example, in U.S. Pat. Nos. 5,920,995; 6,032,374; 6,453,595; 6,681,512; and pre-grant publication US 2002-0124452, but they rely on a very complex and cumbersome set of calculations.

The prior art further teaches particular gunsight reticle grids keyed to the output of reticle-coordinate-calculating computerized devices. These reticle-coordinate-calculating computerized devices accept as input, measurements of environmental conditions, distance to target, inclination to target, and/or ballistics data, and output a particular reticle grid coordinate on which the shot should be centered. This includes U.S. Pat. No. 6,516,699 and pre-grant publication US 2003-0010190.

The prior art also teaches data linkages between particular environmental condition monitors (for example, those produced by KESTREL®, some of which are disclosed in aforementioned U.S. Pat. Nos. 5,783,753 and 5,939,645 and 6,257,074), and particular reticle-coordinate-calculating computerized devices (such as those produced by HORUS VISION™, some of which are disclosed in aforementioned U.S. Pat. No. 6,516,699 and pre-grant publication US 2003-0010190). As a result, the separate steps of: 1) taking a reading of environmental conditions using an environmental conditions monitor, 2) inputting these readings into the computerized device, and 3) outputting the reticle coordinates from the computerized device can all be collapsed into a single step. However, it is still necessary to separately enter distance to target, inclination to target, and firearm and ammunition ballistics data into these reticle-coordinate-calculating computerized devices. And, the reticle coordinates must still be “memorized” by the shooter and then used as the basis for alignment of the firearm, because the computerized device which outputs the reticle coordinates is physically separate and disconnected from the firearm scope and the reticle and does nothing in relation to the scope itself to adjust the aiming.

In sum, while the above-referenced prior art certainly is and improvement over mere guesswork, the systems they embody are still quite cumbersome to employ. The environmental conditions monitors, distance detectors, inclination meters, and reticle-coordinate-calculating computerized devices all remain separate and distinct from the firearm scope, and so even when the environmental conditions monitor and the reticle-coordinate-calculating computerized device are linked, the shooter must still engage in the nine-step process of 1) taking a reading of environmental conditions using environmental conditions monitor 71 which in a linked system feeds directly into the reticle-coordinate-calculating computerized device (in an unlinked system this step itself entails several further steps), 2) taking a reading of distance to target using a distance detector, 3) inputting this distance reading into the reticle-coordinate-calculating computerized device, 4) taking a reading of inclination to target using an inclination meter, 5) inputting this inclination reading into the reticle-coordinate-calculating computerized device, 6) inputting firearm and ammunition ballistics data into the reticle-coordinate-calculating computerized device 7) making a mental note of the reticle coordinates output by reticle-coordinate-calculating computerized device which should be “aimed” at the target, 8) locating those coordinates on the reticle, and 9) centering the shot to be fired on those coordinates. Additionally, even when the shot has been perfectly-centered on perfectly-calculated reticle coordinates, parallax misalignment of the shooter's eye 103 may still introduce inaccuracy into the aiming and shooting.

It would be desirable, therefore, to have a device and associated method which eliminates the nine or more distinct steps just noted, and replaces them with merely a single, simple step.

It would also be desirable to eliminate the inaccuracies introduced by parallax misalignment, both in general, and in relation to reticle grid systems used to account for environmental conditions, target distance, inclination to target, and/or firearm and ammunition ballistics.

Finally, would also be desirable to make use of the technology foundation provided in commonly-invented U.S. Pat. Nos. 6,000,163; 6,363,223; and 6,580,876; and patent application Ser. No. 10/250,148, to simplify the process of accounting for environmental conditions, distance to target, inclination to target, and ammunition ballistics, and eliminate the inaccuracies due to parallax misalignment.

### SUMMARY OF THE INVENTION

Disclosed herein is a firearm scope for use in connection with a firearm, and a related method, comprising: a movable aiming icon viewed juxtaposed with images of a target, automatically movable in relation to the images of the target based on at least one accuracy-affecting factor; whereby: the movable aiming icon can be used to aim the firearm at the target while accounting for the at least one accuracy-affecting factor.

Also disclosed is a firearm scope for use in connection with a firearm, and a related method, comprising: a viewing monitor for displaying in real time, target images captured by a digital imaging array for capturing photographic images of a target; and the viewing monitor situated in relation to the firearm scope, wherein the target images displayed thereon are viewable by a person firing the firearm when firing the firearm; whereby: the target images displayed on the viewing monitor can be used to aim the firearm at the target without parallax misalignment due to variation in positioning of an eye of the person firing the firearm.

Also disclosed is an integrated reticular injection assembly and related method for injecting visual information into an optical path of an optical imaging system, comprising: a substantially transparent and asymmetrically-reflective optical element for simultaneously passing an image therethrough and reflecting the visual information into an optical axis and onto a reticle element of the optical imaging system, thereby juxtaposing the visual information with the image; and the reticle element, proximate to, fixed integrally in relation to, and in combination with, the substantially transparent and asymmetrically-reflective optical element; wherein: the substantially transparent and asymmetrically-reflective optical element and the reticle element are assembled as an integrated assembly separate from, and usable in, the optical imaging system.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) in which:

FIGS. 1 through 6 are replicated from FIGS. 1 through 6 of commonly-invented U.S. Pat. Nos. 6,000,163; 6,363,223; and 6,580,876; and patent application Ser. No. 10/250,148 (U.S. Pat. No. 6,000,163 contains only FIGS. 1 through 3), and illustrate applicant's own prior art from which this disclosure claims priority.

FIG. 7 is a schematic plan view illustrating a rifle scope in a preferred embodiment of the invention, making use of a viewing monitor for displaying an aiming icon juxtaposed on the target image.

FIG. 8 is a plan view of a viewing monitor in the embodiment of FIG. 7, including a movable aiming icon responsive to one or more accuracy-affecting factors.

FIGS. 9-12 are schematic plan views illustrating a rifle scope in several alternative preferred embodiments of the invention, using various lens configurations for displaying an aiming icon juxtaposed on the target image.

FIG. 13 is a plan view illustrating a movable aiming icon responsive to one or more accuracy-affecting factors as displayed in the embodiments of FIGS. 9-12.

### DETAILED DESCRIPTION

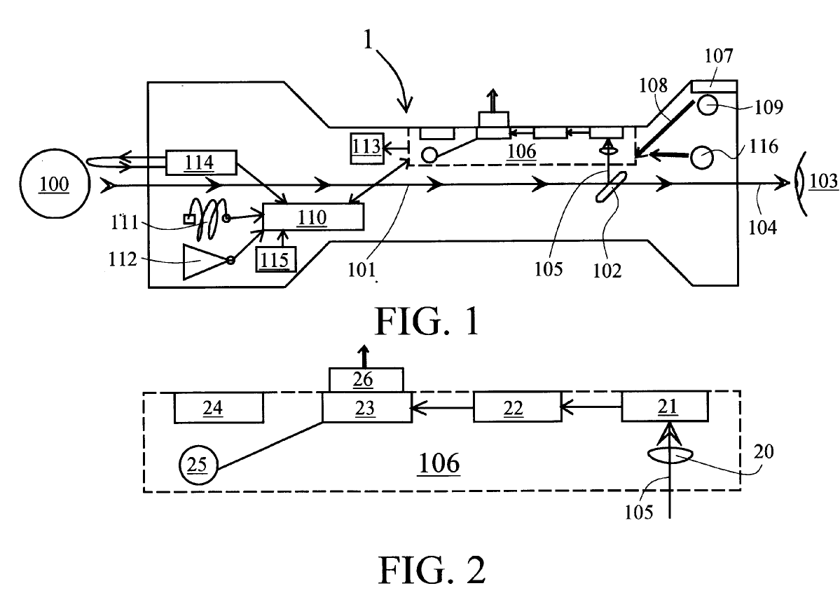

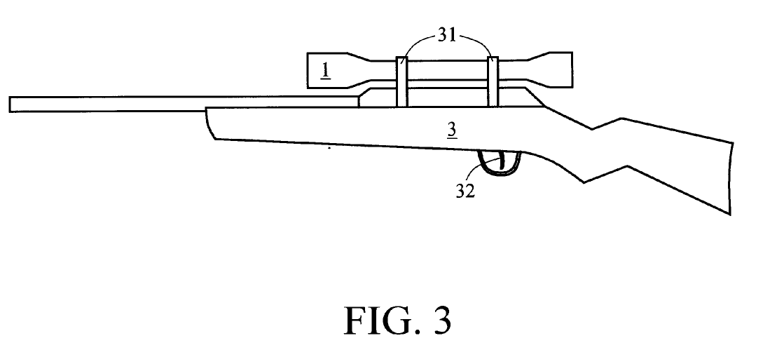

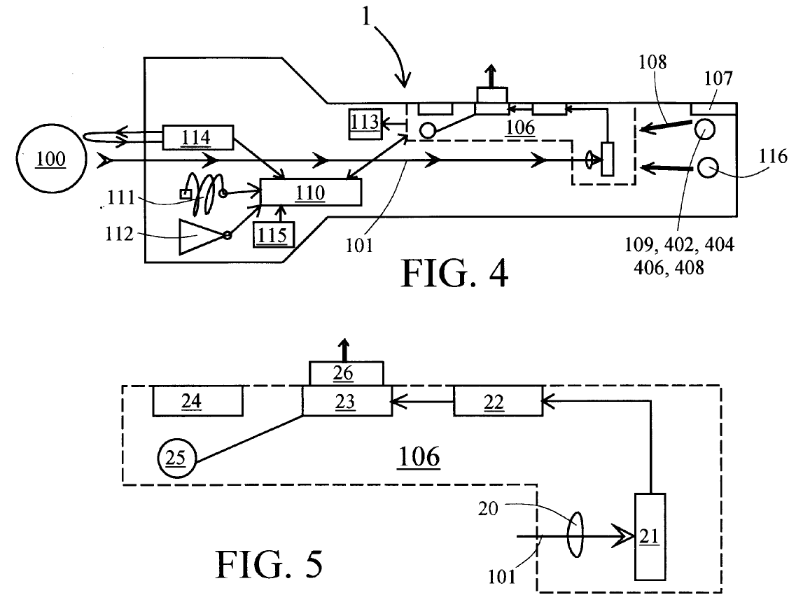

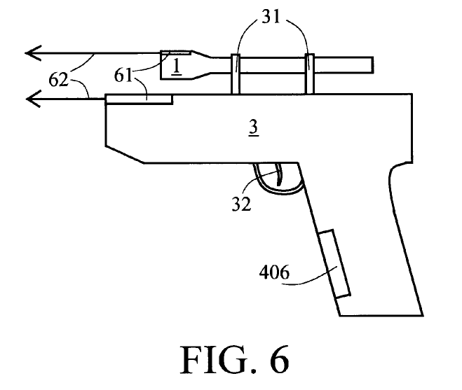

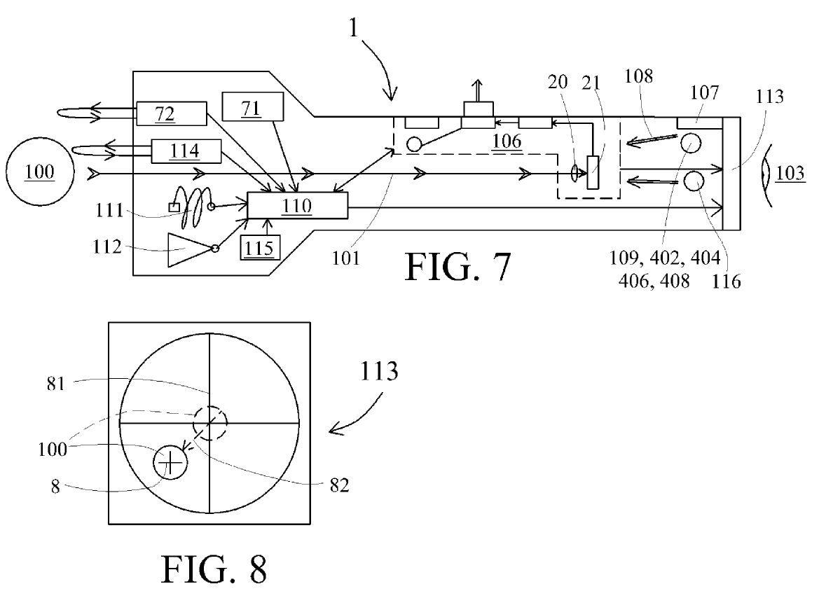

FIG. 7 is based on both FIGS. 1 and 4 insofar as it illustrates a rifle scope 1 through which the shooter can view the target image 100 as in FIG. 1, and insofar as, similarly to FIG. 4, viewing target image 100 directly through a lens is eliminated (or supplemented) in favor of viewing target image 100 on viewing monitor 113, see also FIG. 8.

Particularly, viewing monitor 113 schematically illustrated in FIGS. 1 and 4 is, in FIG. 7, situated upon photographic firearm apparatus 1 in a location such that it is viewable by a person firing the firearm when firing the firearm. Viewing monitor 113 receives image data from digital photography means 106, such that the actual image striking digital imaging array 21 (see also the enlargement of digital photography means 106 in FIG. 5) is displayed on viewing monitor 113 in real time. That is, viewing monitor 113 displays in real time, the target images captured by digital imaging array 21. As such, viewing monitor 113 can replace or supplement a conventional optical scope lens system.

More to the point, the live target image 100, which is already captured by digital photography means 106 in FIGS. 1, 2, 4, and 5, is displayed directly on viewing monitor 113 in real time, and viewing monitor 113 is situated on photographic firearm apparatus 1 such that it can be used in place of (or in combination with) a conventional optical lens system as the basis for aiming and firing at the target.

By taking advantage of the digital photography means 106 and viewing monitor 113 already preexisting in FIGS. 1, 2, 4, and 5 to display real-time target images as just described, parallax misalignments are easily averted. Particularly, as noted earlier, in a lens-based scope system, slight eye 103 misalignments relative to the line of sight 101 cause the target image to present slightly displaced from the crosshairs and therefore can introduce inaccuracies in aiming. However, the real-time display of target images on viewing monitor 113 in FIG. 7 does not depend at all on the placement of the shooter's eye 103. Rather, it is the placement of imaging array 27 relative to line of sight 101 (and line 105 in FIG. 1) that affects this display. Because imaging array 21 can be located in a fixed position relative to these lines of sight 101,105, one can ensure a totally reliable, predictable, replicable display from one shot to the next no matter what the shooter's eye 103 position may be.

FIG. 7 also continues—as in FIGS. 1 and 4—to incorporate a distance detector 114 for measuring distance to target, such as a laser range detector, as known in the art. FIG. 7 also continues—as in FIGS. 1 and 4—to incorporate a computerized device 110. Distance detector 114 continues to provide information to computerized device 110 of FIGS. 1 and 4, and computerized device 110 continues to exchange information with and control digital photography means 106. As in commonly-invented U.S. Pat. Nos. 6,000,163; 6,363,223; and 6,580,876; and patent application Ser. No. 10/250,148, “appropriate ballistics information is pre-programmed into computerized device 110,” including ballistics information about the firearm and the ammunition such as, but not limited to, the ballistic coefficient and muzzle velocity of the ammunition in the intended firearm. Computerized device 110 also controls certain functions of viewing monitor 113 as will be discussed further below, as illustrated by the line from computerized device 110 to viewing monitor 113.

FIG. 7 also illustrates photographic firearm apparatus 1 comprising an environmental conditions monitor 71. Environmental conditions monitor 71 measures some or all of wind velocity (speed and direction), temperature, barometric pressure, relative humidity, elevation above sea level, dew point, wind chill, wet bulb temperature, heat stress, and density altitude. Such environmental conditions monitors 71, as discussed earlier, are known elements in the prior art. Environmental conditions monitor 71 also provides information which it measures to computerized device 110, as illustrated by the line from environmental conditions monitor 71 to computerized device 110.

FIG. 7 also illustrates photographic firearm apparatus 1 comprising an inclination meter 72 for measuring inclination to target, which as discussed earlier, is also an element known in the prior art. Inclination meter 72 also provides information it measures to computerized device 110, as illustrated by the line from inclination meter 72 to computerized device 110. It is understood that distance detector 114 and inclination meter 72 need not be separate devices, but may readily be combined into a single device.

In use, environmental conditions monitor 71, distance detector 114, and inclination meter 72 all feed the data which they detect into computerized device 110. Computerized device 110, as noted above, also contains ballistics data regarding the firearm and the ammunition being employed for shooting. Based on all of this data, computerized device 110 calculates as its output, the appropriate position on the (front or rear) reticle (in the front or rear focal plane) which should be centered over the target, similarly to what was discussed previously in relation to the prior art.

Very importantly, however, as illustrated in FIG. 8, rather than the shooter being required to mentally cross-reference the computerized device 110 output with a grid location on the reticle, an aiming icon 8 (for example, but not in any way limited to the illustrated secondary crosshair) is directly displayed on viewing monitor 113 in juxtaposition with the target image 100. Under control of computerized device 110, aiming icon 8 is movably displayed at the precise reticle position which should be centered over the target to obtain the most accurate shot possible based on the accuracy-affecting factors that were accounted for by computerized device 110. In general, unless computerized device 110 has calculated that no change in aiming is required whatsoever, aiming icon 8 will be movably-displaced horizontally and/or vertically from the primary crosshair 81.

Thus, as shown in broken lines in the illustration of FIG. 8, the shooter centers aiming icon 8 (e.g., the secondary crosshair) rather than primary crosshair 81 over the target 100, thereby moving the firearm aim upwards and to the right by repositioning 82 the target image 100 downward and to the left to juxtapose behind aiming icon 8 in viewing monitor 113. By moving the firearm in this way, the shooter aims and fires so as to fully account for all of the accuracy-affecting factors entering into the calculation by computerized device 110. While aiming icon 8 is illustrated in a crosshair form, an unlimited rage other icons, such as dots, circles, triangles, posts, arrows, or even miniature pictures of animals or—in today's world—terrorist kingpins, can be employed with equal facility within the scope of this disclosure.

Thus, in a single step, computerized device 110 accounts for a broad range of accuracy-affecting factors, determines precisely how the aiming of the firearm should be adjusted in response to these factors, and places a visual aiming icon 8 in rifle scope's viewing monitor for juxtaposition over the target image 100. The shooter understands this to mean, simply, “hold this aiming icon 8 over the target when you fire.” The nine or more steps set forth in the background of the invention are thus collapsed at once into the single step of aiming and shooting using a displaced crosshair or similar aiming icon 8 rather than the primary crosshair 81. All of the myriad of accuracy-affecting factors discussed above are accounted for, in combination, in the positioning of aiming icon 8.

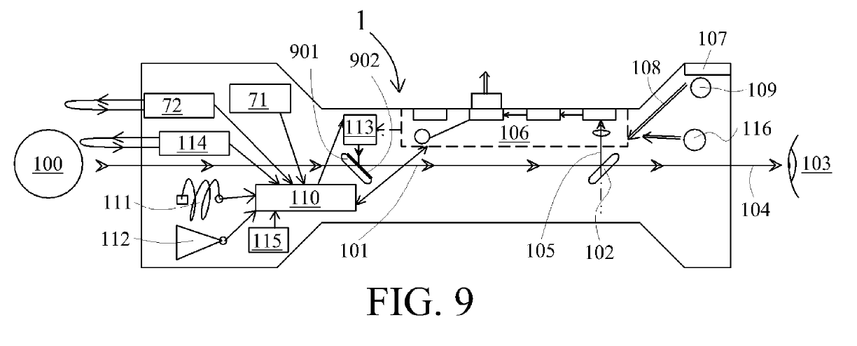

FIGS. 9 through 13 illustrate alternative embodiments of photographic firearm apparatus 1 with the same functional capabilities as embodiments of FIGS. 7 and 8. However, whereas FIGS. 7 and 8 display movable aiming icon 8 using viewing monitor 113, FIGS. 9 through 13 display movable aiming icon 8 using various configurations of optical elements.

FIG. 9 illustrates a substantially-transparent optical element 901 which is also asymmetrically-reflective (one-way mirrored) 902. Light from target 100 passes along optical axis 101, through the substantially-transparent 901 and asymmetrically-reflective 902 optical element (which substantially transmits light emerging therethrough from the left but reflects the light from 113, acting as a “one-way mirror”), through image delivery means, e.g., split prism 102, and to the shooter's eye 103. In this embodiment, as in FIG. 7, computerized device 110 is connected to and controls the display of an aiming icon 8 on viewing monitor 113, as illustrated by the arrow from 110 to 113. As with FIG. 7, aiming icon 8 is positioned on viewing monitor 113 to properly reflect the various factors such as wind, target distance, elevation, ballistics, etc., accounted for by computerized device 110. Viewing monitor 113 in this embodiment is oriented to display aiming icon 8 in a direction illustrated by the downward arrow emerging from viewing monitor 113. This display of aiming icon 8 then reflects 902 off of the one-way mirror of optical element 901, and is injected into the optical axis 101 and onto split prism 102. Because split prism 102 is necessarily in the rear focal plane illustrated by the dash-dot line running through 102 (if it was not, then the image striking to digital photography means 106 would be out of focus) and thus also acts as a reticle element, the aiming icon will appear to the viewer's eye 103 to be superimposed onto the target image 100 when viewed through photographic firearm apparatus 1, as illustrated in FIG. 13.

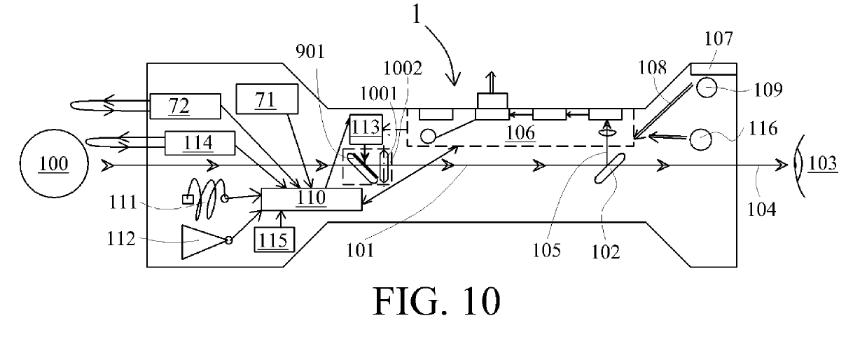

Thus, by using a plurality of optical elements in this manner, aiming icon 8 is injected into the shooter's field of view, and the shooter views the target 100 as well as the aiming icon 8 through the lens system of an ordinary rifle scope, rather than on a viewing monitor 113 as in FIG. 7. The line from 106 to 113 is illustrated as a broken line, because while viewing monitor 113 may still be used as a display device for the image emerging from digital photography means 106, the more important use of viewing monitor 113 in this embodiment is to display the aiming icon 8, positioned under the control of computerized device 110.

Whereas FIG. 9 injects aiming icon 8 into the rear focal plane, in FIG. 10 aiming icon 8 is injected onto an optical reticule 1001 positioned in the front focal plane, also illustrated by a dash-dot line. Again, for proper focusing, aiming icon 8 needs to be injected into either the rear or front focal plane. Everything else in FIG. 10 is the same as in FIG. 9.

Note that in FIG. 10, the combination of an angled, substantially transparent and asymmetrically-reflective optical element 901, 902 and optical reticule 1001 provides an integrated reticular injection apparatus 1102 for injecting aiming icon 8 (or any other visual information from viewing monitor 113) into the optical axis 101. Integrated reticular injection apparatus 1102 has utility more generally for injecting any visual information (e.g., aiming icons, logos, printed matter, etc.) into the optical path of any optically-based imaging system. This combination of a substantially transparent and asymmetrically-reflective optical element for simultaneously passing an image therethrough and reflecting the visual information into an optical axis and onto a reticle element of the imaging system, thereby juxtaposing the visual information with the image; and the reticle element, proximate to, fixed integrally in relation to, and in combination with, the substantially transparent and asymmetrically-reflective optical element; wherein: the substantially transparent and asymmetrically-reflective optical element and the reticle element are assembled as an integrated assembly separate from, and usable in, the optical imaging system, is preferably packaged as a stand-alone apparatus that may be employed in a wide range of optical imaging systems.

In sum, FIGS. 9 and 10 comprise a substantially transparent and asymmetrically-reflective optical element for simultaneously passing the images of the target therethrough and reflecting the movable aiming icon into an optical axis and onto a reticle element of the firearm scope, thereby juxtaposing the movable aiming icon with the images of the target. In FIG. 9, the reticle element into which the aiming icon is reflected resides in a rear focal plane of the firearm scope. In FIG. 10, the reticle element into which the aiming icon is reflected resides in a front focal plane of the firearm scope.

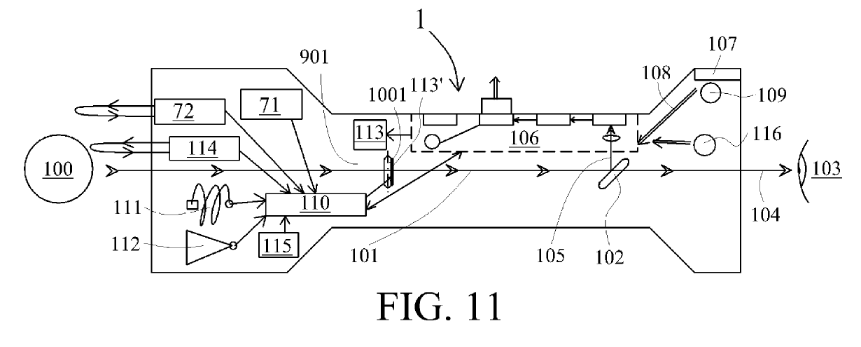

FIG. 11 has the same functional objectives as FIGS. 9 and 10, namely, to view aiming icon 8 through the lens system of an ordinary rifle scope, rather than on a viewing monitor 113 as in FIG. 7. In FIG. 11, however, the substantially transparent and asymmetrically-reflective optical element 901 of FIGS. 9 and 10 is eliminated in favor of a transmissive LCD viewer 113′ which is overlaid directly upon optical reticule 1001 in the front focal plane. Transmissive LCD viewer 113′ is controlled by computerized device 110 (as indicated by the arrow from 110 to 113′), and in particular, computerized device 110 causes transmissive LCD viewer 113′ to display aiming icon 8 at the proper location required to account for the various accuracy-affecting factors feeding into the computer 110 calculations.

Transmissive LCD viewer 113′ is essentially a transparent LCD element which allow light to pass therethrough, but which at the same time can display LCD images in whatever manner is designated by the computer controlling these transmissive LCD viewers. Such a device may be implemented using an LCD, but without the usual rear reflective coating or backlight To provide contrast necessary to see aiming icon 8, one may, for example, combine a transmissive LCD with edge light. Or, for example, one may develop the contrast using the natural light coming through the scope. More generally, transmissive LCD viewer 113′, in the manner of conventional LCDs, can display any sort of information which one might wish to display, not merely aiming icons. And, a transmissive LCD viewer 113′ may be employed as an element in other applications as well, wherever it might be desired to superimpose the display of information over a transparent medium such as a lens/reticule, a plate of plastic or glass, etc.

By overlaying transmissive LCD viewer 113′—or any similar device known or which may become known in the art—over optical reticule 1001, aiming icon 8 is injected directly into the field of view without the further optical elements introduced in FIGS. 9 and 10.

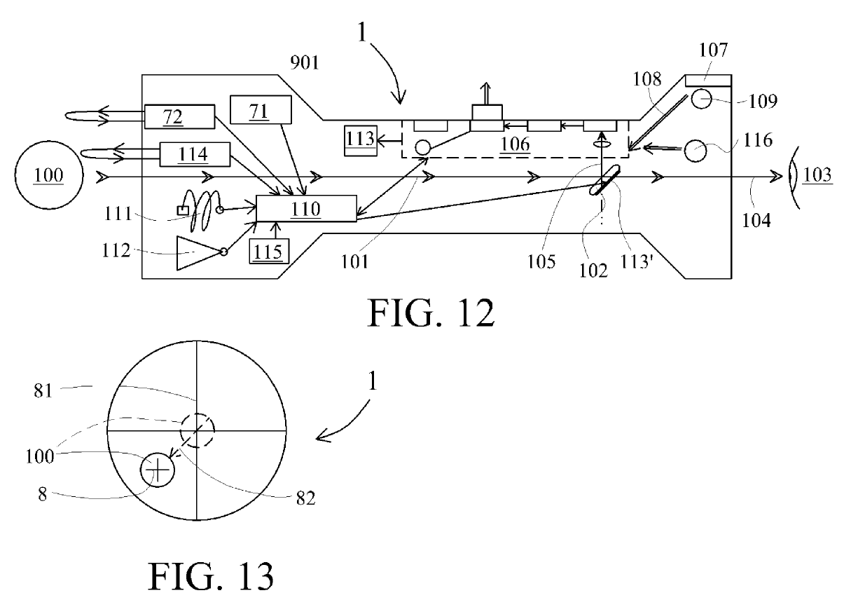

FIG. 12 is similar in all respects to FIG. 11, however, the transmissive LCD viewer 113′ is overlaid directly upon image delivery means 102, e.g., the split prism in the rear focal plane.

In sum, FIGS. 11 and 12 comprise a transmissive LCD viewer for displaying the movable aiming icon, overlaid over a reticle element of the firearm scope, thereby juxtaposing the movable aiming icon with the images of the target. In FIG. 11, the reticle element into which the transmissive LCD viewer is overlaid resides in a front focal plane of the firearm scope. In FIG. 12, the reticle element into which the transmissive LCD viewer is overlaid resides in a rear focal plane of the firearm scope.

In all of FIGS. 9-12, the net result is the same: aiming icon 8 is injected onto at least one of the optical elements of photographic firearm apparatus 1, for viewing in juxtaposition with images of target 100, so that aiming can be adjusted to account for at least one accuracy-affecting factor.

While FIGS. 9 trough 12 show several embodiments for injecting the aiming icon into the shooter's field of view in a conventional optical firearm scope, it will be appreciated by people of ordinary skill that there may be other ways to achieve the same results. Such alternatives are also to be regarded as being within the scope of this disclosure and its associated claims.

FIGS. 9 through 12 provide an alternative to FIG. 7 which allows the aiming icon to be displayed in a conventional scope system, and allows the shooter to aim and shoot through a conventional lens set, rather than to aim and shoot using the display viewer of FIG. 7. While the benefits of avoiding parallax misalignment cannot be assured with FIGS. 9 through 12 in the same manner as with FIG. 7, there are individuals and organizations who may feel that it is important—for varying reasons—to aim and shoot using the optics of a conventional firearm scope, in the “traditional” manner, and who do not wish to aim at a target by looking an electronic display as illustrated in FIG. 7. FIGS. 9 through 12 address the “traditional” desires of these users, while still providing the improved aiming achieved by accounting for environmental conditions, target distance, target inclination, and ballistics, and posting an aiming icon which shows the proper place to aim based on this diverse combination of factors.

Finally, it is important to note that viewer-based systems such as that of FIGS. 7 and 8, and more traditional lens-based systems such as those of FIGS. 9 through 13, are not mutually exclusive. It is contemplated that in a combined embodiment, the aiming icon 8 may be injected into the conventional optical path employing devices and methods such as those disclosed in FIGS. 9 through 12, and that a direct viewing monitor 113 with aiming icon 8 thereon may also be provided in the manner of FIGS. 7 and 8, situated such that target images and the aiming icon displayed thereon are viewable by the person firing the firearm when firing the firearm. This would give the user a choice of employing one or the other, or both, of the electronic display and the conventional optics when aiming and shooting. Such a combined system may be realized by someone of ordinary skill, in a very straightforward manner, based on the disclosures herein, and within the scope of the associated claims.

While only certain preferred features of the invention have been illustrated and described, many modifications and changes will occur to those skilled in the art. It is, therefore, to be understood that the appended claims are intended to cover all such modifications and changes as fall within the true spirit of the invention.

1. A firearm scope for improving accuracy when aiming and firing a firearm, comprising:
a movable aiming icon viewed juxtaposed with images of a target, automatically movable in relation to said images of the target based on at least one accuracy-affecting factor; whereby:
said movable aiming icon can be used to aim the firearm at the target while accounting for said at least one accuracy-affecting factor.

2. The firearm scope of [Claim 1], further comprising:
a plurality of optical elements; and
an icon injector for injecting said movable aiming icon onto at least one of said optical elements for viewing in juxtaposition with said images of the target, based on said at least one accuracy-affecting factor.

3. The firearm scope of [Claim 2], said icon injector comprising:
a substantially transparent and asymmetrically-reflective optical element for simultaneously passing said images of the target therethrough and reflecting said movable aiming icon into an optical axis and onto a reticle element of said firearm scope, thereby juxtaposing said movable aiming icon with said images of the target.

4. The firearm scope of [Claim 3], wherein:
said reticle element into which said aiming icon is reflected resides in a front focal plane of said firearm scope.

5. The firearm scope of [Claim 3], wherein:
said reticle element into which said aiming icon is reflected resides in a rear focal plane of said firearm scope.

6. The firearm scope of [Claim 1], further comprising:
a viewing monitor for viewing said images of the target by displaying in real time, target images captured by a digital imaging array for capturing photographic images of the target;
said viewing monitor displaying said movable aiming icon in juxtaposition with said target images, based on said at least one accuracy-affecting factor; whereby:
said target images displayed on said viewing monitor can be used to further aim the firearm at the target without parallax misalignment due to variation in positioning of an eye of the person firing the firearm.

7. The firearm scope of [Claim 1], said at least one accuracy-affecting factor comprising at least one environmental condition, further comprising:
an environmental conditions monitor for measuring said at least one environmental condition.

8. The firearm scope of [Claim 7], said at least one environmental condition comprising wind velocity.

9. The firearm scope of [Claim 7], said at least one environmental condition comprising temperature.

10. The firearm scope of [Claim 7], said at least one environmental condition comprising at least one environmental condition selected from the environmental condition group consisting of: barometric pressure, relative humidity, elevation above sea level, dew point, wind chill, wet bulb temperature, heat stress, and density altitude.

11. The firearm scope of [Claim 1], said at least one accuracy-affecting factor comprising a distance to the target, further comprising:
a distance detector for measuring said distance to the target.

12. The firearm scope of [Claim 1], said at least one accuracy-affecting factor comprising ballistics data pertaining to ammunition to be fired from the firearm, further comprising:
a computerized device containing said ballistics data therein.

13. The firearm scope of [Claim 1], said at least one accuracy-affecting factor comprising an inclination to the target, further comprising:
an inclination meter for measuring said inclination to the target.

14. The firearm scope of [Claim 7], said at least one accuracy-affecting factor further comprising a distance to the target, further comprising:
a distance detector for measuring said distance to the target.

15. The firearm scope of [Claim 7], said at least one accuracy-affecting factor further comprising ballistics data pertaining to ammunition to be fired from the firearm, further comprising:
a computerized device containing said ballistics data therein.

16. The firearm scope of [Claim 7], said at least one accuracy-affecting factor further comprising an inclination to the target, further comprising:
an inclination detector for measuring said inclination to the target.

17. The firearm scope of [Claim 14], said at least one accuracy-affecting factor further comprising ballistics data pertaining to ammunition to be fired from the firearm, further comprising:
a computerized device containing said ballistics data therein.

18. The firearm scope of [Claim 14], said at least one accuracy-affecting factor further comprising an inclination to the target, further comprising:
an inclination detector for measuring said inclination to the target.

19. The firearm scope of [Claim 15], said at least one accuracy-affecting factor further comprising an inclination to the target, further comprising:
an inclination detector for measuring said inclination to the target.

20. The firearm scope of [Claim 17], said at least one accuracy-affecting factor further comprising an inclination to the target, further comprising:
an inclination detector for measuring said inclination to the target.

21. The firearm scope of [Claim 11], said at least one accuracy-affecting factor comprising ballistics data pertaining to ammunition to be fired from the firearm, further comprising:
a computerized device containing said ballistics data therein.

22. The firearm scope of [Claim 11], said at least one accuracy-affecting factor comprising an inclination to the target, further comprising:
an inclination meter for measuring said inclination to the target.

23. The firearm scope of [Claim 21], said at least one accuracy-affecting factor comprising an inclination to the target, further comprising:
an inclination meter for measuring said inclination to the target.

24. The firearm scope of [Claim 12], said at least one accuracy-affecting factor comprising an inclination to the target, further comprising:
an inclination meter for measuring said inclination to the target.

25. A firearm scope for improving accuracy when aiming and firing a firearm, comprising:
a viewing monitor for displaying in real time, target images captured by a digital imaging array for capturing photographic images of a target; and
said viewing monitor situated in relation to said firearm scope, wherein said target images displayed thereon are viewable by a person firing the firearm when firing the firearm; whereby:
said target images displayed on said viewing monitor can be used to aim the firearm at the target without parallax misalignment due to variation in positioning of an eye of the person firing the firearm.

26. The firearm scope of [Claim 25], further comprising:
said digital imaging array.

27. The firearm scope of [Claim 25], further comprising:
a movable aiming icon automatically movable in relation to said target images based on at least one accuracy-affecting factor, displayed on said viewing monitor in juxtaposition with said target images based on said at least one accuracy-affecting factor; whereby:
said movable aiming icon can be used to further aim the firearm at the target while accounting for said at least one accuracy-affecting factor.

28. An integrated reticular injection assembly for injecting visual information into an optical path of an optical imaging system, comprising:
a substantially transparent and asymmetrically-reflective optical element for simultaneously passing an image therethrough and reflecting said visual information into an optical axis and onto a reticle element of the optical imaging system, thereby juxtaposing said visual information with said image; and
said reticle element, proximate to, fixed integrally in relation to, and in combination with, said substantially transparent and asymmetrically-reflective optical element; wherein:
said substantially transparent and asymmetrically-reflective optical element and said reticle element are assembled as an integrated assembly separate from, and usable in, the optical imaging system.

29. A method for improving accuracy when aiming and firing a firearm, comprising:
juxtaposing a movable aiming icon for viewing juxtaposed with images of a target, using a firearm scope of the firearm; and
automatically moving said movable aiming icon in relation to said images of the target based on at least one accuracy-affecting factor; whereby:
said movable aiming icon can be used to aim the firearm at the target while accounting for said at least one accuracy-affecting factor.

30. The method of [Claim 29], further comprising:
injecting said movable aiming icon onto at least one optical element of said firearm scope for viewing in juxtaposition with said images of the target, based on said at least one accuracy-affecting factor.

31. The method of [Claim 30], said injecting comprising:
using a substantially transparent and asymmetrically-reflective optical element for simultaneously passing said images of the target therethrough and reflecting said movable aiming icon into an optical axis and onto a reticle element of said firearm scope, thereby juxtaposing said movable aiming icon with said images of the target.

32. The method of [Claim 31], further comprising:
residing said reticle element into which said aiming icon is reflected, in a front focal plane of said firearm scope.

33. The method of [Claim 31], further comprising:
residing said reticle element into which said aiming icon is reflected, in a rear focal plane of said firearm scope.

34. The method of [Claim 29], further comprising:
displaying in real time, target images captured by a digital imaging array for capturing photographic images of the target, using a viewing monitor for viewing said images of the target;
displaying said movable aiming icon in juxtaposition with said target images, based on said at least one accuracy-affecting factor, further using said viewing monitor; whereby:
said target images displayed on said viewing monitor can be used to further aim the firearm at the target without parallax misalignment due to variation in positioning of an eye of the person firing the firearm.

35. The method of [Claim 29], said at least one accuracy-affecting factor comprising at least one environmental condition, further comprising:
measuring said at least one environmental condition using an environmental conditions monitor.

36. The method of [Claim 35], said at least one environmental condition comprising wind velocity.

37. The method of [Claim 35], said at least one environmental condition comprising temperature.

38. The method of [Claim 35], said at least one environmental condition comprising at least one environmental condition selected from the environmental condition group consisting of: barometric pressure, relative humidity, elevation above sea level, dew point, wind chill, wet bulb temperature, heat stress, and density altitude.

39. The method of [Claim 29], said at least one accuracy-affecting factor comprising a distance to the target, further comprising:
measuring said distance to the target using a distance detector.

40. The method of [Claim 29], said at least one accuracy-affecting factor comprising ballistics data pertaining to ammunition to be fired from the firearm, further comprising:
containing said ballistics data in a computerized device.

41. The method of [Claim 29], said at least one accuracy-affecting factor comprising an inclination to the target, further comprising:
measuring said inclination to the target using an inclination meter.

42. The method of [Claim 35], said at least one accuracy-affecting factor further comprising a distance to the target, further comprising:
measuring said distance to the target, using a distance detector.

43. The method of [Claim 35], said at least one accuracy-affecting factor further comprising ballistics data pertaining to ammunition to be fired from the firearm, further comprising:
containing said ballistics data in a computerized device.

44. The method of [Claim 35], said at least one accuracy-affecting factor further comprising an inclination to the target, further comprising:
measuring said inclination to the target, using an inclination detector.

45. The method of [Claim 42], said at least one accuracy-affecting factor further comprising ballistics data pertaining to ammunition to be fired from the firearm, further comprising:
containing said ballistics data in a computerized device.

46. The method of [Claim 42], said at least one accuracy-affecting factor further comprising an inclination to the target, further comprising:
measuring said inclination to the target, using an inclination detector.

47. The method of [Claim 43], said at least one accuracy-affecting factor further comprising an inclination to the target, further comprising:
measuring said inclination to the target, using an inclination detector.

48. The method of [Claim 45], said at least one accuracy-affecting factor further comprising an inclination to the target, further comprising:
measuring said inclination to the target, using an inclination detector.

49. The method of [Claim 38], said at least one accuracy-affecting factor comprising ballistics data pertaining to ammunition to be fired from the firearm, further comprising:
containing said ballistics data in a computerized device.

50. The method of [Claim 38], said at least one accuracy-affecting factor comprising an inclination to the target, further comprising:
measuring said inclination to the target, using an inclination detector.

51. The method of [Claim 49], said at least one accuracy-affecting factor comprising an inclination to the target, further comprising:
measuring said inclination to the target, using an inclination detector.

52. The method of [Claim 40], said at least one accuracy-affecting factor comprising an inclination to the target, further comprising:
measuring said inclination to the target, using an inclination detector.

53. A method for improving accuracy when aiming and firing a firearm, comprising:
situating a viewing monitor relation to a firearm scope, wherein said target images displayed thereon are viewable by a person firing the firearm when firing the firearm; and
displaying in real time using said viewing monitor, target images captured by a digital imaging array for capturing photographic images of a target; whereby:
said target images displayed on said viewing monitor can be used to aim the firearm at the target without parallax misalignment due to variation in positioning of an eye of the person firing the firearm.

54. The method of[Claim 53], further comprising:
said firearm scope comprising said digital imaging array.

55. The method of [Claim 53], further comprising:
displaying a movable aiming icon on said viewing monitor in juxtaposition with said target images; and
automatically moving said movable aiming icon in relation to said target images based on at least one accuracy-affecting factor; whereby:
said movable aiming icon can be used to further aim the firearm at the target while accounting for said at least one accuracy-affecting factor.

56. A method for injecting visual information into an optical path of an optical imaging system, comprising:
assembling as an integrated reticular injection assembly separate from, and usable in, the optical imaging system:
a substantially transparent and asymmetrically-reflective optical element for simultaneously passing an image therethrough and reflecting said visual information into an optical axis and onto a reticle element of the optical imaging system, thereby juxtaposing said visual information with said image; and
said reticle element, proximate to, fixed integrally in relation to, and in combination with, said substantially transparent and asymmetrically-reflective optical element.
